(19) United States
(12) Patent Application Publication
(10) Pub. No.: US 2009/0084675 A1
(43) Pub. Date: Apr. 2, 2009

(54) Ion adsorption electrode, electosorption purification device having the same and method of manufacturing the electrode

(75) Inventors: Jea Bong Lee, Daeojon (KR); Kwang Kyu Park, Daejeon (KR); Seok Won Yoon, Daejeon (KR); Pill Yang Park, Daejeon (KR)

Correspondence Address: IPHORGAN, LTD., 1130 LAKE COOK ROAD, SUITE 240, BUFFALO GROVE, IL, 60089, US

(73) Assignee: Korea Electric Power Corporation, Seoul (KR)

(21) Appl. No.: 12/074,814

(22) Filed: Mar. 6, 2008

(30) Foreign Application Priority Data
Sep. 27, 2007 (KR) 10-2007-0097561

(51) Int. Cl. C25B 9/00; C25B 11/12; B29D 31/00

(52) U.S. Cl. 204/294; 204/242; 264/109

(57) ABSTRACT

An ion adsorption electrode having large electrical capacity and ion adsorption capacity, an electosorption purification device having the same, and a method of manufacturing the ion adsorption electrode, the ion adsorption electrode including active carbon, a binder and an ion exchange resin. The electosorption purification device includes: an anode adsorbing and desorbing anions among inorganic ions in water; a cathode, facing the anode, adsorbing and desorbing cations among inorganic ions in water; and a direct current supply respectively applying voltages to the anode and cathode, where the anode and cathode may include the active carbon, binder and ion exchange resin. The method of manufacturing the ion adsorption electrode includes: preparing a mixture by mixing active carbon powder, a binder and an ion exchange resin with each other; and forming the mixture in a predetermined thickness by pressing the mixture.

### CROSS-REFERENCE TO RELATED APPLICATIONS (CLAIM FOR PRIORITY)

This application is based on and claims priority to Korean Patent Application No. 10-2007-0097561 filed on Sep. 27, 2007, in the Korean Intellectual Property Office (KIPO), the entire contents of which are hereby incorporated by reference.

### BACKGROUND OF THE INVENTION

1. Field of the Invention

The present invention relates to an electosorption purification device that can remove inorganic ions included in river water, water/sewage and sea water by electrical force, and an ion adsorption electrode used in the purifying device and a method of manufacturing the electrode.

2. Description of the Related Art

Generally, purification methods for the inorganic ions include an ion-exchange method, a reverse osmosis membrane method, an evaporation method and an electrodialysis method. However, the methods as described above have many disadvantages such as high energy consumption, generation of secondary pollutants, difficult maintenance. Thus, an electrosorption purification device purifying water by using electrical energy has been developed recently.

The electosorption purification device uses various carbon electrodes for ion adsorption. The carbon electrodes include an active carbon cloth electrode, a carbon aerogel electrode and a carbon composite electrode. The carbon aerogel electrode has a low ion adsorption capacity. The active carbon cloth electrode has a high ion adsorption capacity, but is expensive. Thus, the carbon composite electrode is relatively desirable because of easy manufacturing process, relatively low manufacturing cost and high ion adsorption capacity. Generally, the carbon composite electrode is manufactured by using active carbon, carbon black, binder, etc.

However, active carbon of a usual carbon composite electrode has a non-polar property and thus, has a hydrophobic property. Accordingly, desalination performance of the carbon composite electrode is degraded. Thus, the carbon composite electrode has a disadvantage in that a separate surface treatment should be performed for the electrode with isopropyl alcohol or potassium hydroxide, etc. to prevent degradation of the desalination performance. In addition, long time and additional processes are required for the surface treatment. The desalination performance is not so much improved in spite of the surface treatment because the surface of the electrode is not completely changed into a hydrophilic surface.

### SUMMARY OF THE INVENTION

Accordingly, an object of the present invention is to provide an ion adsorption electrode, an electosorption purification device having the same and a method of manufacturing the electrode that can improve ion adsorption capacity by forming a hydrophilic surface of the electrode.

Additional advantages, objects and features of the invention will be set forth in part in the description which follows and in part will become apparent to those having ordinary skill in the art upon examination of the following or may be learned from practice of the invention.

According to an aspect of the present invention, there is provided an ion adsorption electrode, which includes active carbon, a binder and an ion exchange resin. Here, a content of the ion exchange resin may be 1 to 50 wt % of a total amount. More desirably, the content of the ion exchange resin may be 12 to 36 wt % of the total amount, and in this time, a content of the active carbon may be 60 to 84 wt % of the total amount.

The binder may be polytetrafluoroehtylene (PTFE). The ion adsorption electrode may further include conductive carbon. On the other hand, the ion adsorption electrode may be formed in a plate shape by mixing the binder and ion exchange resin with each other and pressing the mixture thereof.

According to another aspect of the present invention, there is provided an electosorption purification device, which includes: an anode adsorbing and desorbing anions among inorganic ions in water; a cathode, facing the anode, adsorbing and desorbing cations among inorganic ions in water; and a direct current supply respectively applying voltages to the anode and cathode, where the anode and cathode may include the active carbon, binder and ion exchange resin. Here, a content of the active carbon may be 60 to 84 wt %, and a content of the ion exchange resin may be 12 to 36 wt %.

According to a still another aspect of the present invention, there is provided a method of manufacturing the ion adsorption electrode, which includes: preparing a mixture by mixing active carbon powder, a binder and an ion exchange resin with each other; and forming the mixture in a predetermined thickness by pressing the mixture. Here, a content of the active carbon may be 60 to 84 wt %, and a content of the ion exchange resin may be 12 to 36 wt %.

### BRIEF DESCRIPTION OF THE DRAWING FIGURES

The above and other objects, features and advantages of the present invention will be more apparent from the following detailed description taken in conjunction with the accompanying drawing, in which:

FIG. 1 is a schematic view illustrating an electosorption purification device according to one exemplary embodiment of the present invention;

FIGS. 2a to 2c are schematic views illustrating a manufacturing process of an electrode according to one exemplary embodiment of the present invention;

FIG. 3 is a photograph illustrating a contact angle measurement test for the ion adsorption electrode according to an experimental example of the present invention;

FIGS. 4a and 4d are SEM photographs illustrating surfaces of each electrode;

FIG. 5 is a graph illustrating current-voltage circulation of each electrode; and

FIG. 6 is a graph illustrating desalination performance of each electrode.

### DETAILED DESCRIPTION OF PREFERRED EMBODIMENTS

Hereinafter, preferred embodiments of the present invention will be described in detail with reference to the accompanying drawing.

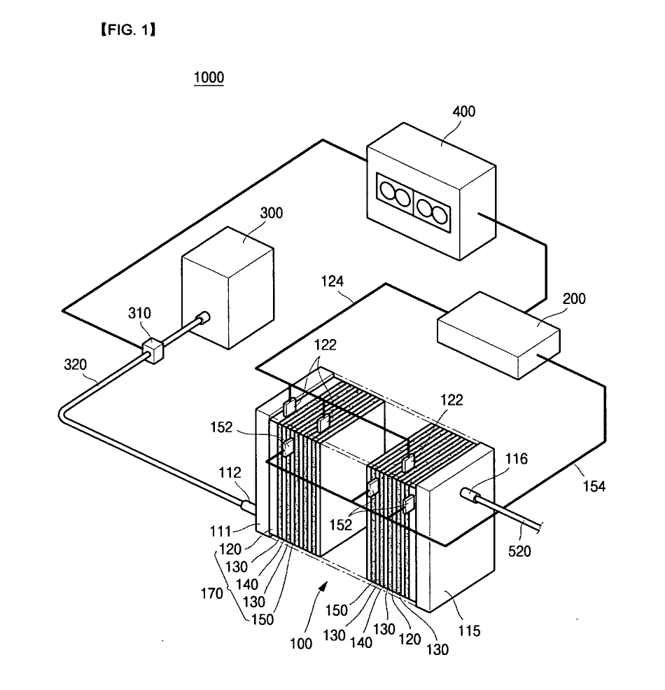

FIG. 1 shows a schematic view illustrating an electosorption purification device according to one exemplary embodiment of the present invention.

Referring to FIG. 1, the electosorption purification device 1000 includes an electrical adsorbing/desorbing reactor 100 that adsorbs cations and anions among inorganic in water and then removes them by desorption, and a power supply 200 applying direct current power to the electrical adsorbing/desorbing reactor 100.

As shown in FIG. 1, the electosorption purification device 1000 may further include a sewage tank 300 storing sewage and a controller 400 controlling the power supply 200.

The electrical adsorbing/desorbing reactor 100 includes first and second support plates 111 and 115 and at least one electrode stack 170, where the electrode stack includes an anode collector 120, an ion adsorption electrode 130, a spacer 140 and a cathode collector 150. Both ends of the stacked structure of several electrode stacks 171 are supported by the first and second support plates 111 and 115.

As shown in the drawing, the electrode stack 170 may be freely provided in multi-stacks according to an amount of water. On the other hand, the ion adsorption electrode 130 included in the electrical adsorbing/desorbing reactor 100 is formed by mixing active carbon, a binder and an ion exchange resin with each other. The ion adsorption electrode 130 uses the ion exchange resin instead of conventionally used carbon black. Thus, desalination performance is improved because property of the electrode 130 is changed from hydrophobic into hydrophilic by using the ion exchange resin.

An inlet 112 is formed at the first support plate 111. Sewage water is flowed in along an inflow tube 320 through the inlet 112 from the sewage tank 300. An outlet 116 is formed at the second support plate 115 for discharging purified water through an outflow tube 520. In addition, the anode and cathode collectors 120 and 150 respectively include anode and cathode tabs 122 and 152. The anode and cathode collectors 120 and 150 are respectively connected to positive and negative power supply lines 124 and 154 so as to be supplied with direct current power from the power supply 200.

The controller 400 opens a valve 310 of the sewage tank 300, thereby allowing the sewage including inorganic ions stored in the sewage tank 300 to be flowed into the electrical adsorbing/desorbing reactor 100. The inorganic ions included in the sewage are adsorbed to the ion adsorption electrode 130 having a polarity opposite to the inorganic ions. Then, the power supply 200 applies an opposite voltage to the electrical adsorbing/desorbing reactor 100. Thus, the adsorbed ions are desorbed and the inorganic ions are removed. In this time, purification efficiency can be more improved because the ion adsorption electrode 130 included in the electrical adsorbing/desorbing reactor 100 is formed of a hydrophilic material as described above. In addition, a large amount of sewage can be quickly purified by constructing the electrode stack 170 in multi stages.

The ion adsorption electrode and a manufacturing method thereof according to one exemplary embodiment of the present invention will be explained in more detain below.

The ion adsorption electrode 130 includes active carbon, a binder and an ion exchange resin.

The flat type ion adsorption electrode for purifying sea water includes active carbon adsorbing ions in sea water and PTFE as the binder maintaining properties of the electrode as main components. When a desalination electrode is used, property of adsorption holes largely affects on ion adsorption in usual electrolytes. However, effect of surface area is largest for purifying sea water. Active carbon particles having surface area of 2,500 m²/g, adsorption hole volume more than 1.2 mL/g, density of 0.35 to 0.45 g/mL, particle size of 9 to 10 μm are used. Powder type ion exchange resin is used. PTFE solution of 60% is used as the binder.

In this time, a content of the ion exchange resin may be 1 to 50 wt % in comparison to the entire ion adsorption electrode. If the content of the ion exchange resin is less than 1 wt %, it is difficult to secure hydrophilic property. If the content of the ion exchange resin is more than 50 wt %, an ion adsorption capacity is lowered because the amount of the active carbon is relatively reduced.

More desirably, the content of the ion exchange resin may be 12 to 36 wt % in comparison to the entire ion adsorption electrode. The content of the active carbon may be 60 to 84 wt %. When the content of the active carbon is in the range as described above and the content of the ion exchange resin is 12 wt %, water drops are completely absorbed at the time of measuring a contact angle described later. Thus, hydrophilic property is more improved. When the content of the ion exchange resin is less than 36 wt %, adhesive force of the ion adsorption electrode can be kept stronger by securing the content of the binder of a proper amount.

Polytetrafluoroethylene (PTFE) is used as the binder. PTFE keeps the plate shape of the electrode by preventing the active carbon and the ion exchange resin from being separated from each other and binding them together.

On the other hand, the ion adsorption electrode may further include conductive carbon. The conductive carbon may be added under the condition that the property of the ion adsorption electrode secures hydrophilic property. The hydrophilic property of the ion adsorption electrode is secured by adding the conductive carbon of a predetermined amount, and electric conductivity is also improved. Here, a content of the conductive carbon can be freely controlled.

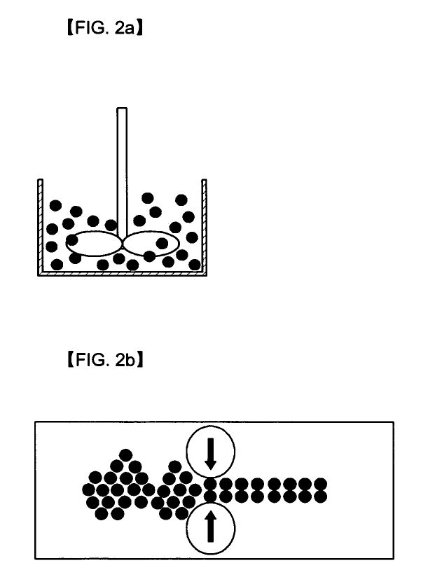

FIGS. 2a to 2c show schematic views illustrating a manufacturing process of an electrode according to one exemplary embodiment of the present invention;

The manufacturing process of the ion adsorption electrode includes the steps of: (a) preparing a mixture of active carbon powder, a binder and an ion exchange resin; and (b) forming the mixture in a predetermined thickness by pressing the mixture.

First, referring to FIG. 2a, in the step (a), each component is put in a solvent and then mixed and kneaded. In this time, the active carbon and the ion exchange resin powder are put in a beaker in a weight ration of 3.5:1, and then dried at 150° C. in an oven. Dried active carbon and ion exchange resin powder are put in an agitator, and then agitated at 30 rpm for two hours. After the mixing is completed, water of 80 g is added to a PTFE solution of 60 g. Then, after the solution is agitated for one hour, the solution is added to the carbon mixture and then agitated at 30 rpm for three hours. In this time, the binder is agitated at a speed that does not generate foam. Next, water 100 g, isopropyl alcohol 10 g are added and agitated at a normal temperature for 15 minutes. After 15 minutes, the mixture solution is added to the agitator including the binder, and further agitated at 30 rpm for three hours. Water 40 g and isopropyl alcohol 30 g are put in the beaker and then further agitated at a normal temperature for 15 minutes. After 15 minutes, the mixture solution is added to the agitator, and further agitated at 50 rpm for 24 hours. After the agitation is completed, the mixture is formed in a type of granules having a diameter of about 5 mm. After the agitation, the mixture is left for 48 hours for aging. In this time, the mixture is sealed by vinyl for preventing rapid evaporation of water.

Next, referring to FIG. 2b, in the step (b), the mixture is in a state that organic binding force is very weak in each other. Thus, the mixture is wrapped with an aluminum foil for preventing the mixture from being poured in rolling. A temperature of a roller is kept at 50° C., and a rolling speed is kept at 2 m/min. A space between the rollers is about 1.5 mm at the beginning. Rolling is continuously performed by twice times while the space between the rollers is reduced by 70 to 80 μm.

Next, referring to FIG. 2c, when a thickness of the mixture becomes 1 mm, the mixture is formed in a rectangular shape by cutting its peripheral parts, and then rolled again. After the mixture is cut to form the rectangular shape, the temperature of the roller is increased to 70° C., and the roller space is reduced by 50 μm. Then, rolling is performed by three times for each thickness. When the thickness becomes 200 μm, the rolling is stopped. The completed electrode is cut in a proper size. The finally manufactured electrode is dried at 80° C for three hours. After drying, the electrode is kept so as not to be wound or folded. The binder covers surfaces of the components in a cobweb shape by the pressing process as described above. In other words, the gelated binder is changed into fibers like threads by heating at the time of pressing, thereby keeping the electrode in a plate shape.

An experimental example of the present invention will be explained in more detail, but not limited thereto.

### EXPERIMENTAL EXAMPLE

In the experimental example, ion adsorption electrodes having various compositions were manufactured and contact angle, surface appearance, electrical capacity and desalination performance of the ion adsorption electrodes were evaluated as shown in Table 1.

TABLE 1

| Kind of electrode | Composition (wt %) |
|---|---|
| CS (comparison example) | active carbon particle:PTFE:conductive |
| | carbon = 84:4:12 |
| CI-1 (experimental example 1) | active carbon particle:PTFE:ion |
| | exchange resin = 84:4:12 |
| CI-1 (experimental example 2) | active carbon particle:PTFE:ion |
| | exchange resin = 72:4:24 |
| CI-1 (experimental example 3) | active carbon particle:PTFE:ion |
| | exchange resin = 60:4:36 |

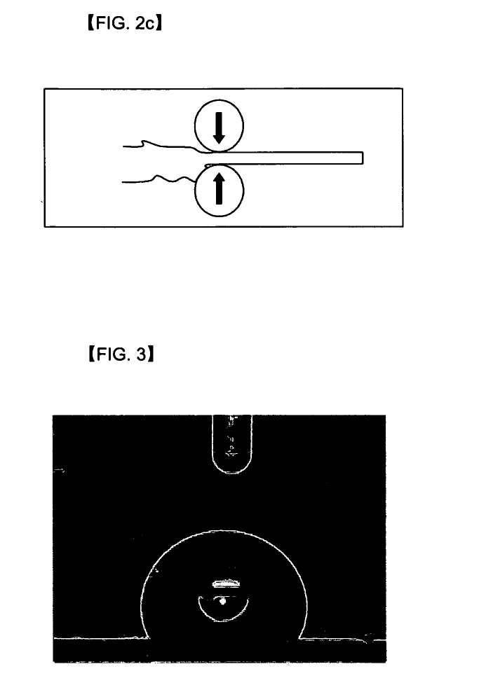

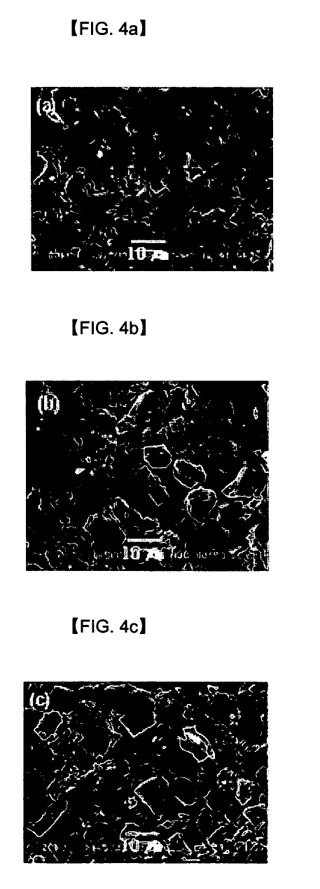

FIG. 3 shows a photograph illustrating a contact angle measurement test for the ion adsorption electrode according to the experimental example, and FIGS. 4a and 4d are SEM photographs illustrating surfaces of each electrode;

Referring to FIG. 3, the contact angle of CS electrode was 115°. The contact angle of CS electrode could not be measured because all water drops are absorbed in the electrode immediately after the water drops fell down on the surface of the electrode. Thus, in consideration of the result, it was identified that the CS electrode is hydrophobic and the CI electrode is hydrophilic. This result can be identified by SEM images of the electrodes according to the example shown in FIG. 4. It was almost impossible to observe cavities in the CS(a) because of clumped body of the active carbon particle and conductive carbon. However, many cavities could be observed in CI-1(b), CI-2(c) and CI-3(d).

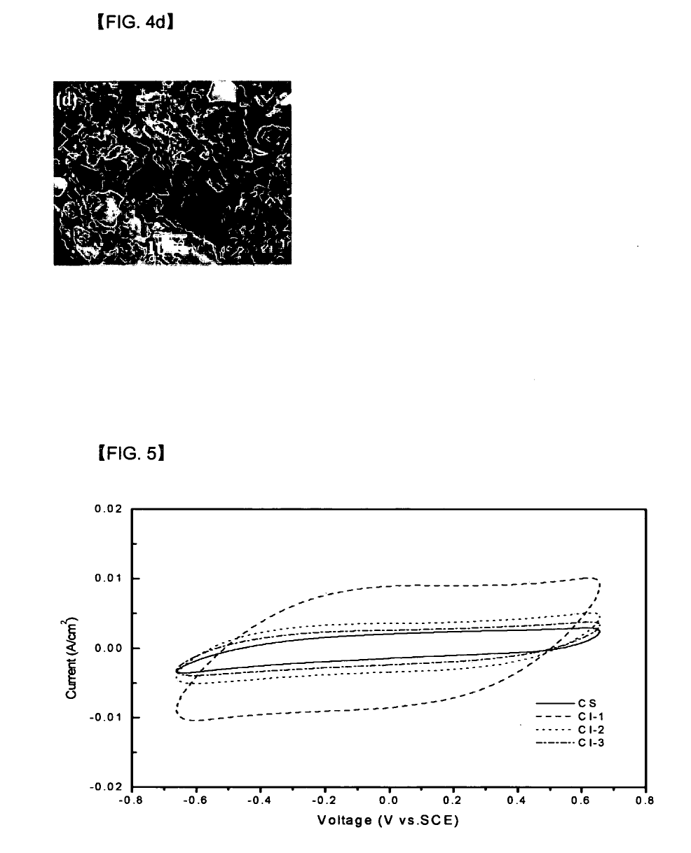

FIG. 5 shows a graph illustrating current-voltage circulation of each electrode;

An electrical capacity of each electrode was measured at a scan speed of 2 mV/s. As shown in the current-voltage circulation graph of FIG. 5, the electrical capacity of each electrode is larger than that of the CS electrode. On the other hand, the electrical capacity of CI-1 electrode is larger than that of other electrodes. Here, the composition of the electrode showing best performance was the composition that the ratio of the active carbon particle:PTFE:ion exchange resin was 84:4:12 wt %.

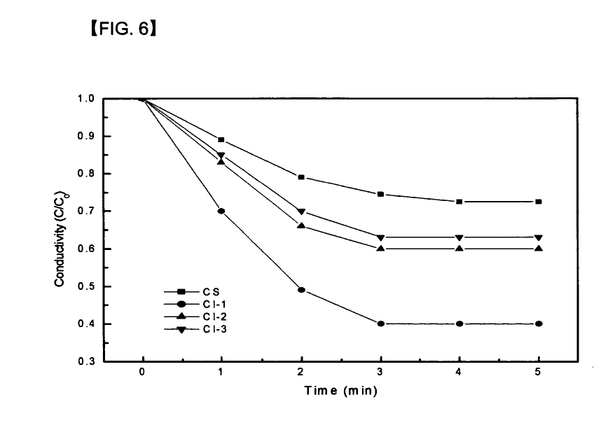

FIG. 6 shows a graph illustrating desalination performance of each electrode.

In an electrosorption device, water was flowed in a flow rate of 80 ml/minute between two electrodes having height of 100 mm, width of 100 mm and thickness of 0.6 mm that face each other, and then a direct current of 1.4V was applied. Then, the desalination performance of each electrode was measured. C0 indicates an initial concentration, and C indicates a concentration after the electrode passed through the desalination device, and NaCl solution of 0.5M was used.

The desalination performance of the CS electrode was 26% after 240 seconds after the operation was started. The desalination performance of the electrodes CI-1, CI-2 and CI-3 were respectively 60%, 36% and 33% after 120 seconds. The desalination performances of the CI electrodes were better than that of the CS electrode. Here, the desalination performance of the CI-1 electrode was better than that of other CI electrodes.

As described above, the ion adsorption electrode, electosorption purification device having the same and method of manufacturing the electrode according to the present invention produce the following effect.

The ion adsorption capacity is increased by reforming the surface of the electrode into the hydrophilic surface, thereby allowing purification performance of the electosorption purification device to be prominently improved.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. An ion adsorption electrode, comprising active carbon, a binder and an ion exchange resin.

2. The ion adsorption electrode of claim 1, wherein a content of the ion exchange resin is 1 to 50 wt % of a total amount.

3. The ion adsorption electrode of claim 1, wherein the content of the ion exchange resin is 12 to 36 wt % of the total amount

4. The ion adsorption electrode of claim 3, wherein a content of the active carbon is 60 to 84 wt % of the total amount.

5. The ion adsorption electrode of claim 1, wherein the binder is polytetrafluoroehtylene (PTFE).

6. The ion adsorption electrode of claim 1, further comprising conductive carbon.

7. The ion adsorption electrode of claim 1, wherein the ion adsorption electrode is formed in a plate shape by mixing the binder and ion exchange resin with each other and pressing the mixture thereof.

8. An electosorption purification device, comprising:
an anode adsorbing and desorbing anions among inorganic ions in water;
a cathode, facing the anode, adsorbing and desorbing cations among inorganic ions in water; and
a direct current supply respectively applying voltages to the anode and cathode,
where the anode and cathode comprise active carbon, binder and ion exchange resin.

9. The electosorption purification device of claim 8, wherein the content of the active carbon is 60 to 84 wt %, and the content of the ion exchange resin is 12 to 36 wt %.

10. A method of manufacturing an ion adsorption electrode, comprising:
preparing a mixture by mixing active carbon powder, a binder and an ion exchange resin with each other; and
forming the mixture in a predetermined thickness by pressing the mixture.

11. The method of manufacturing the ion adsorption electrode according to claim 10 wherein the content of the active carbon is 60 to 84 wt %, and the content of the ion exchange resin is 12 to 36 wt %.

12. An ion adsorption electrode manufactured by the method of claim 10.

13. An ion adsorption electrode manufactured by the method of claim 11.
